(19) United States
(12) Patent Application Publication
(10) Pub. No.: US 2025/0328406 A1
(43) Pub. Date: Oct. 23, 2025

(54) MATCHING MEMORY DUMPS USING MACHINE CODE INSTRUCTIONS

(71) Applicant: International Business Machines Corporation, Armonk, NY (US)

(72) Inventors: Harry Morgan WILLIAMS, Bristol (GB); Erhan MENGUSOGLU, Southhampton (GB); Ana Carolina CAMARASAN, Sheffield (GB); Matthew Peter WAKEHAM, Southhampton (GB)

(21) Appl. No.: 18/641,936

(22) Filed: Apr. 22, 2024

(51) Int. Cl. G06F 11/07

(52) U.S. Cl. CPC G06F 11/0778; G06F 11/0721; G06F 11/0775; G06F 11/079

(57) ABSTRACT

Embodiments of the present disclosure provide methods, systems, and computer program products for analyzing and matching similarity of operating system memory dumps to assign a developer for a given error event causing a computing failure. A disclosed embodiment includes generating trace information of the memory dump to identify an instruction causing the system failure and a memory location of the instruction; extracting a plurality of machine code instructions preceding the instruction causing the system failure based on the memory location, and removing a data part and not operations of the instructions being executed, from the plurality of machine code instructions. In addition, a list of operations of the machine code instructions is generated and compared to a plurality of reference memory dumps to identify similarity values of the plurality of reference memory dumps to the memory dump.

### BACKGROUND

The present invention relates to data processing field, and more specifically, to techniques for analyzing operating system (OS) memory dumps to resolve computer system problems.

Typically, an operating system memory dump is obtained to collect specific data used for diagnosing and resolving computer system problems and error events, such as a computing system failure, or an abnormal program termination. New techniques are needed for processing operating system memory dumps for effectively and efficiently diagnosing and resolving computer system problems.

### SUMMARY

Embodiments of the present disclosure are directed to a methods, systems, and computer program products for analyzing and identifying similarity of operating system memory dumps, or memory dumps, to assign a developer for a given error event causing a computing system failure.

According to one embodiment of the present disclosure, a non-limiting computer implemented method is provided. The method comprises obtaining a memory dump for a given error event causing a system failure; generating trace information of the memory dump to identify an instruction causing the system failure and a memory location of the instruction; extracting a plurality of machine code instructions preceding the instruction causing the system failure based on the memory location, removing a data part and not operations of instructions being executed from the plurality of machine code instructions, to generate a list of operations of the machine code instructions; and comparing the list of operations of the machine code instructions to a plurality of reference memory dumps to identify similarity values of the plurality of reference memory dumps to the memory dump.

Other disclosed embodiments include systems, and computer program products for analyzing and matching operating system memory dumps, implementing features of the above-disclosed method.

### BRIEF DESCRIPTION OF THE DRAWINGS

FIG. 1 is a block diagram of an example computer environment for use in conjunction with one or more disclosed embodiments;

FIG. 2 is a block diagram of an example system for implementing memory dump analysis of one or more disclosed embodiments;

FIGS. 3A, and 3B together provide a flow chart of an example method for implementing memory dump analysis of one or more disclosed embodiments;

FIG. 4 is an example work flow diagram of an example method for implementing memory dump analysis of one or more disclosed embodiments;

FIG. 5 illustrates example trace instruction entries of an example memory dump of one or more disclosed embodiments;

FIGS. 6A, and 6B respectively illustrate an example new memory dump example and reference memory dumps used for implementing memory dump analysis of one or more disclosed; and

FIG. 7 is a flowchart illustrating a method for implementing memory dump analysis of a disclosed embodiment.

### DETAILED DESCRIPTION

Embodiments herein describe techniques for analyzing and matching operating system memory dumps using automated processing tools. In an embodiment, an operating system memory dump is obtained and analyzed to identify a given problem and find a memory location where the problem occurred. A disclosed embodiment includes generating trace information of a new memory dump to identify a memory location of an instruction causing the system failure, and assigning the dump to a certain problem area using a similarity measure from trace information. An embodiment performs analysis of a plurality of instructions executed before a memory location where the problem occurred causing the new memory dump, where data parts are removed (e.g., and not the operations being done) from the plurality of instructions and a list of operations are built that enable matching other reference dumps which have had similar processing. A disclosed embodiment enables matching of the new memory dump with reference memory dumps, where the compared memory dumps are caused by similar issues and include changes to the code, which are not applicable to traditional direct string and function comparison methods. Disclosed embodiments perform analysis using a problem area that is identified from trace information of the memory dump, remove data parts and not the operations of instructions being executed from a plurality of instructions preceding an instruction causing the memory dump, and build a list of operations of the plurality of instructions that can be matched to other reference dumps, which had similar processing. Disclosed embodiments can significantly reduce analysis time and efficiently assign an available subject matter expert or program developer for a given error event causing a system failure over traditional processes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

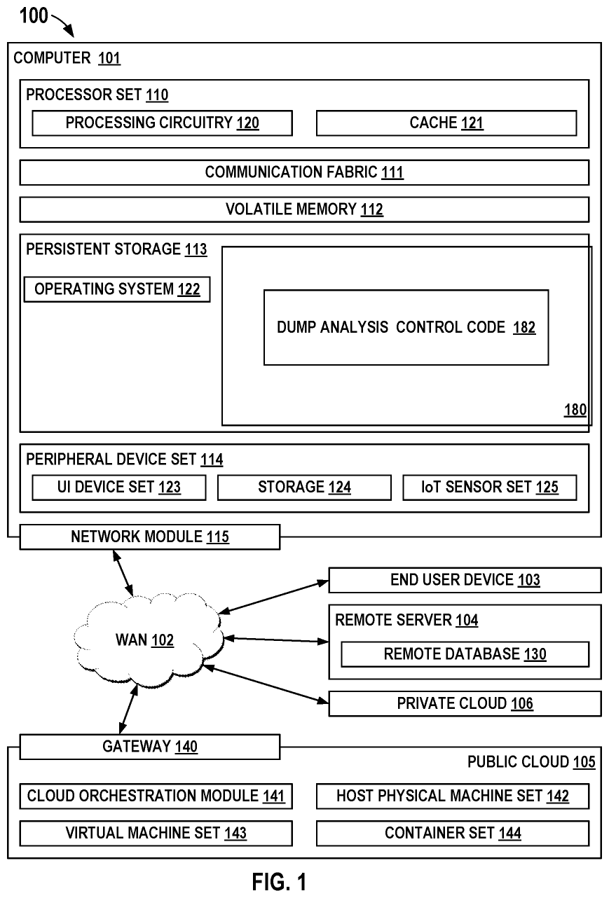

Referring to FIG. 1, a computing environment 100 contains an example of an environment for the execution of at least some of the computer code involved in performing the inventive methods, such as a Dump Analysis Control Code 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

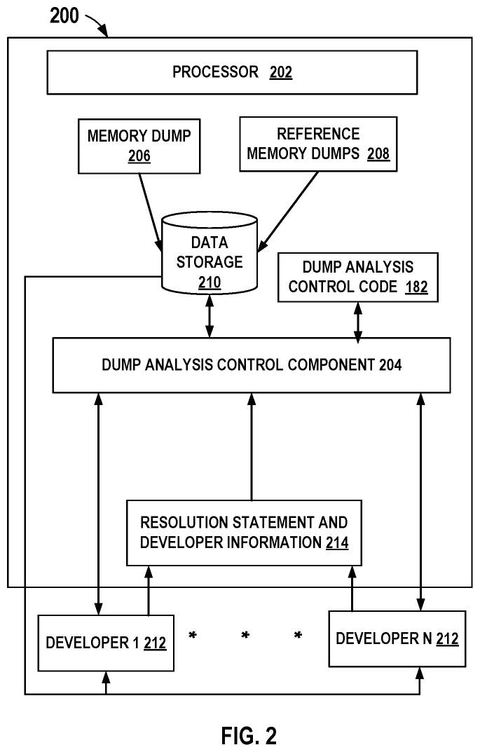

FIG. 2 illustrates a system 200 for implementing memory dump analysis of one or more disclosed embodiments. System 200 can be used in conjunction with the computer 101 and cloud environment of the computing environment 100 of FIG. 1 with the Dump Analysis Control Code 182 for implementing methods according to one or more embodiments.

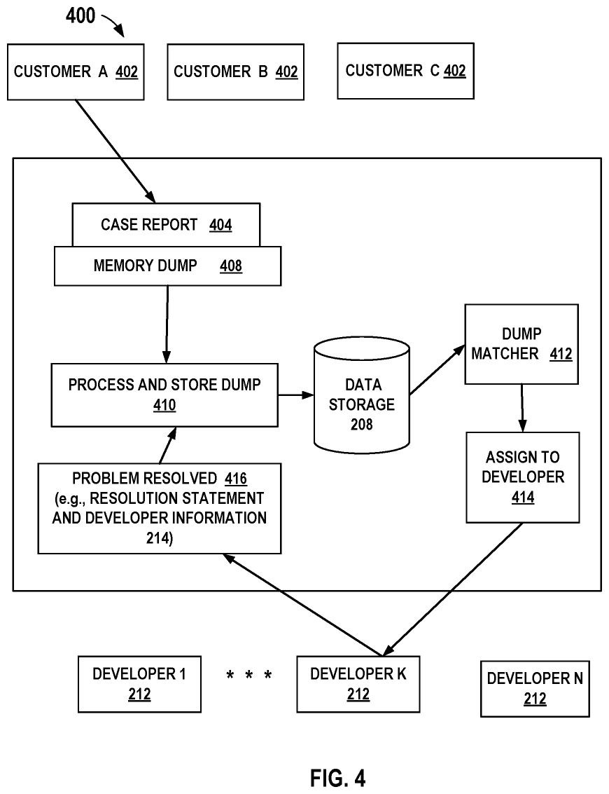

In a disclosed embodiment, system 200 includes one or more processors 202, and a Dump Analysis Control component 204 with the Dump Analysis Control Code 182 for implementing methods of disclosed embodiments. System 200 includes a new memory dump 206 to be processed using a plurality of reference memory dumps 208 of disclosed embodiments. System 200 includes a data storage 210 for storing the new memory dump 206, processing updates of the new memory dump 206, the plurality of reference memory dumps 208, together with a case report 404 and a resolution statement and developer information 214, such as illustrated and described with respect to FIG. 4.

In a disclosed embodiment, system 200 identifies and assigns one of a plurality of available developers 1-N, 212 based on similarity comparing and matching the new memory dump 206 with one or more reference memory dumps 208, and stored developer information, which includes labels by experience based on similarity comparing in accordance with disclosed embodiments. In a disclosed embodiment, system 200 receives and stores a resolution statement and developer information in the data storage 210 when the problem is resolved by disclosed analyzing and matching methods for the new memory dumps 206.

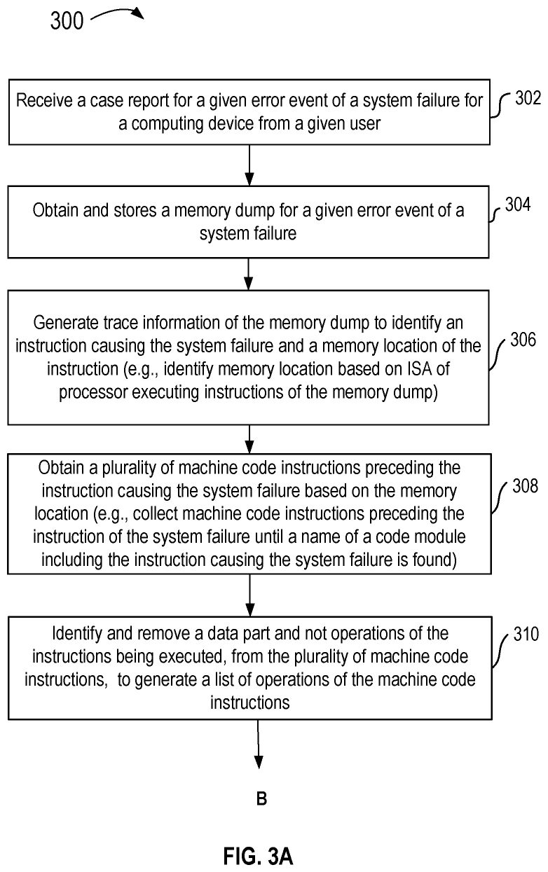

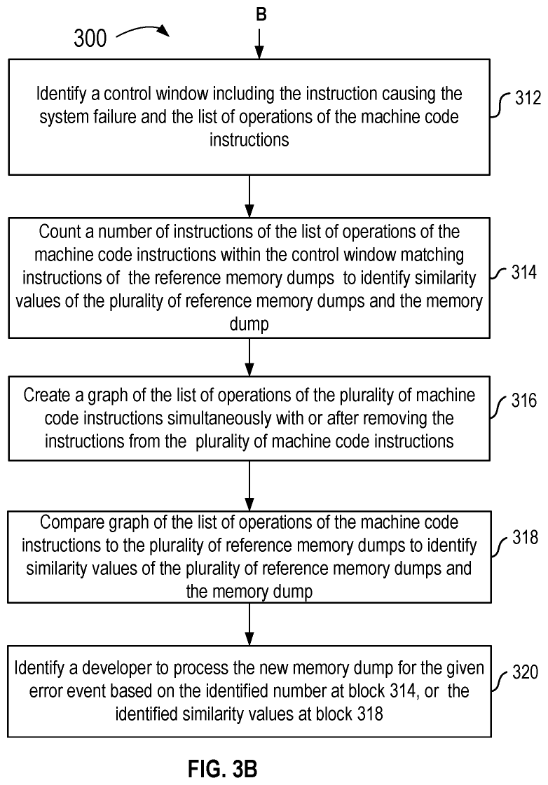

FIGS. 3A, and 3B together provide a flow chart of an example method 300 for implementing memory dump analysis of one or more disclosed embodiments. Method 300 can be implemented by system 200 in conjunction with the Dump Analysis Control Code 182, the computer 101 and cloud environment of the computing environment 100 of FIG. 1 of disclosed embodiments.

At block 302, system 200 optionally receives a case report 404 for a system problem or error event of a computing system. For example, system 200 receives a system input for a given customer A, B, C 402 providing a case report 404 as shown in FIG. 4. At block 304, system 200 obtains and stores a new memory dump (e.g., new operating system memory dump) for a given error event causing a system failure. System 200 stores one or more of a system description or case report of the memory dump, and when the system problem is resolved, system 200 stores a resolution statement for the memory dump, and developer information of a developer assigned to process the memory dump. In this example, the new memory dump is stored in a data storage with a plurality of reference memory dumps that have been processed and resolved in accordance with disclosed embodiments.

At block 306, system 200 generates trace information of the memory dump to identify an instruction causing the system failure and a memory location of the instruction. In a disclosed embodiment, system 200 identifies the memory location based on an instruction set architecture (ISA) of a processor executing the machine code instructions of the system failure. For example, identifies the memory location based on domain knowledge, such as a Complex Instruction Set Computer (CICS) processor executing CPU instructions or machine code instructions for the given error event of the system failure.

At block 308, system 200 obtains a plurality of machine code instructions preceding the instruction causing the system failure based on the memory location, identified at block 306. In a disclosed embodiment, system 200 starts at the memory location of the instruction causing the system failure and goes backwards a plurality of machine code instructions or instruction statements being executed that resulted in the system failure. For example, system 200 starts at the instruction causing the system failure, and collects a plurality of instructions preceding the failure instruction until a name of the code module that includes the instruction causing the system failure is found.

At block 310, system 200 identifies and removes a data part and not operations of of instructions being executed from the plurality of machine code instructions to generate a list of operations of the machine code instructions. System 200 advantageously compares the list of operations of the machine code instructions to stored reference memory dumps, to identify memory dumps having similar processing operations. Using the list of operations of the machine code instructions for analyzing and comparing memory dumps by system 200 enables successfully comparing new memory dumps with stored reference memory dumps to identify similarity values of the reference memory dumps to the memory dump. Operations continue at block 312 following entry point B in FIG. 3B.

In FIG. 3B, at block 312, system 200 optionally identifies a control window including the instruction causing the system failure and the list of operations of the machine code instructions, which omits the data parts or data elements. At block 314, system 200 counts a number of instructions within the control window that match instructions in the respective reference memory dumps in order to identify similarity values of the memory dumps. At block 316, system 200 optionally creates a graph of the list of operations of the plurality of machine code instructions, simultaneously with or after removing the data parts, and not operations of instructions being executed from the plurality of machine code instructions at block 310 of FIG. 3A. At block 318, system 200 compares the graph of the list of operations of the machine code instructions to the plurality of reference memory dumps to identify similarity values of the plurality of reference memory dumps to the memory dump. At block 320, system 200 identifies a developer to process the memory dump for the given error event, based on the count number obtained at block 314, or based on the similarity values identified at block 318. System 200 can efficiently assign an available developer for a given error event in accordance with disclosed embodiments.

FIG. 4 illustrates an example workflow method 400 for implementing memory dump analysis of one or more disclosed embodiments. A plurality of user systems or customers A, B, C 402 start method with a case report 404 for a system problem or error event of a computing system, (such as shown in block 302 of FIG. 3). As shown, customer A 402 provides the case report and a memory dump 408, (e.g., operating system memory dump) of operating system instructions (e.g., CPU instructions or machine code instructions) including a given instruction causing an error event of a system failure. At block 410, the memory dump 408 is processed and stored into a data storage 208. At block 412, a dump matcher process is performed, such as illustrated and described above with respect to FIGS. 3A, and 3B, to identify and assign one of a plurality of available subject matter experts or developers 1-N, 212 to the new memory dump at block 414. An identified Developer K, 212 of the developers 1-N, 212 receives and processes the new memory dump. As shown at block 416 with the problem resolved, a resolution statement and developer information is received and processed at block 410 and stored for the memory dump in the data storage 208.

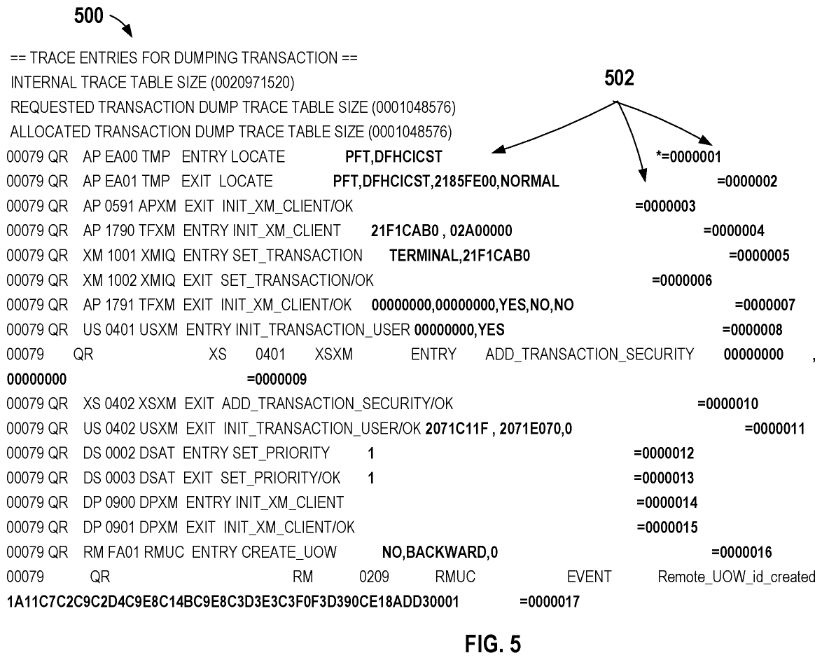

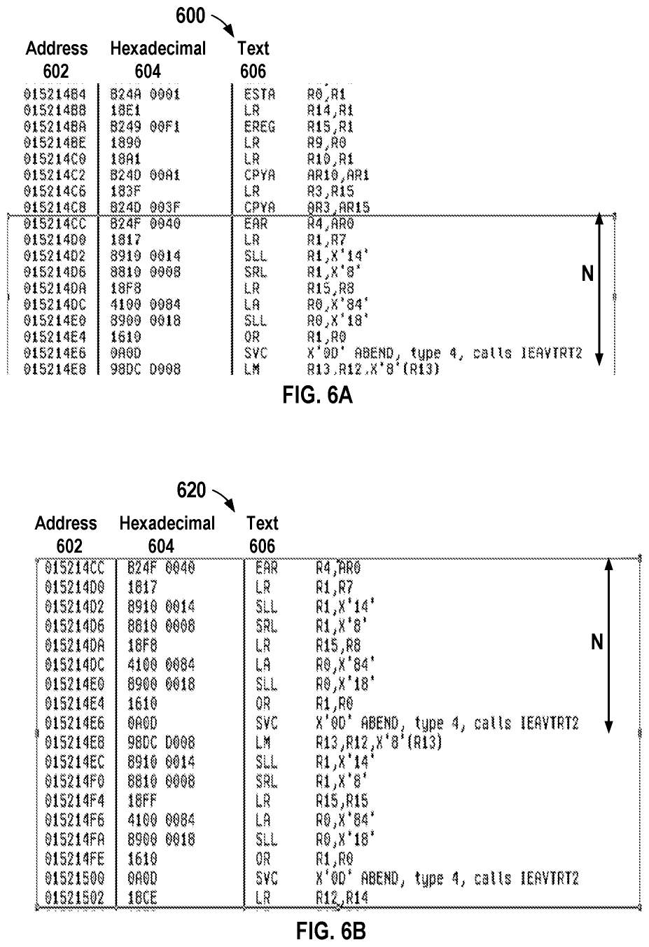

FIG. 5 illustrates example trace instruction entries 500 of an example memory dump 206 of one or more disclosed embodiments. Trace instruction entries 500 represent example instructions of a given memory dump 206, which include a data part 502 shown in bold. In disclosed embodiments, the data parts 502 of the plurality of instructions obtained from the trace information and not the operations being executed, are removed from the plurality of machine code instructions preceding the instruction causing the system failure to generate a list of operations of plurality of machine code instructions. In disclosed embodiments, the removal of the data parts 502 from the collected plurality of instructions enables effective and efficient analysis and comparing of the new memory dump 206 with reference memory dumps 208. Examples lists of operations of plurality of machine code instructions, which omit the data parts are illustrated and described in FIGS. 6A, and 6B.

FIGS. 6A, and 6B respectively illustrate an example new memory dump 600 and example reference memory dumps 620 used for implementing memory dump analysis of one or more disclosed embodiments. Each instruction in the illustrated new memory dump 600 and the reference memory dumps 620 includes an Address 602, a Hexadecimal 604 representation of the instruction, and Text 606 representation of human readable version of a given instruction (e.g., CPU instructions). A respective arrow labeled N shown within the example memory dump 600 and the example reference memory dumps 620 represents the list of operations of the plurality of instructions to be analyzed, (e.g., the list of operations of the machine code instructions omitting data parts and not the operations of instructions being executed) preceding an example instruction causing the error event of the system failure (e.g. X′ΘD′ ABEND, type 4, calls IEAVTRT2, shown with a respective associated address.

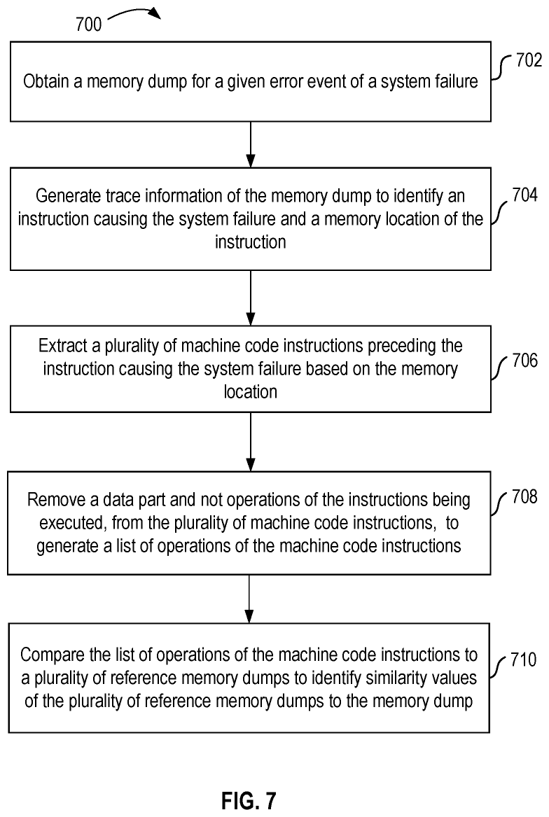

FIG. 7 is a flowchart illustrating a method for implementing memory dump analysis of a disclosed embodiment. Method 700 can be implemented by system 200 in conjunction with the Dump Analysis Control Code 182, the computer 101 and cloud environment of the computing environment 100 of FIG. 1 of disclosed embodiments.

At block 702, system 200 obtains a memory dump for a given error event causing a system failure. For example, system 200 obtains a memory dump with a case report of a system problem or error event of a computing system, such as shown in block 302 of FIG. 3; and with a system input or a customer A 402 providing a case report 404, such as shown in FIG. 4.

At block 704, system 200 generates trace information of the memory dump to identify an instruction causing the system failure and a memory location of the instruction. For example, system 200 identifies the memory location causing the error event of the system failure based on an instruction set architecture (ISA) of a processor executing the machine code instructions of the system failure, (e.g., based on domain knowledge of a Complex Instruction Set Computer (CICS) processor). At block 707, system 200 extracts a plurality of machine code instructions preceding the instruction causing the system failure based on the memory location. In a disclosed embodiment, system 200 obtains the plurality of machine code instructions, starting at the instruction causing the system failure, and collecting the plurality of instructions until a name is found for a code module including the instruction causing the system failure, as described at block 308 in FIG. 3A.

At block 708, system 200 removes data elements and not operations of instructions being executed, from the plurality of machine code instructions, to generate a list of operations of the machine code instructions. In a disclosed embodiment, system 200 obtains the plurality of machine code instructions and generates the list of operations of the machine code instructions as described at blocks 308 and 310 in FIG. 3A. In an embodiment, system 200 uses the list of operations of the machine code instructions to identify similarity values of the plurality of stored reference memory dumps to the memory dump. In a disclosed embodiment, system 200 creates a graph of the list of operations of the machine code instructions, and system 200 compares the graph of the list of operations to the plurality of reference memory dumps to identify similarity values of the plurality of reference memory dumps and the memory dump. In a disclosed embodiment, system 200 identifies a control window including the instruction causing the system failure and the list of operations of the machine code instructions; and counts a number of instructions within the control window of the memory dump matching respective reference memory dumps to identify similarity values of the plurality of reference memory dumps and the memory dump.

At block 710, system 200 compares the list of operations of the machine code instructions to a plurality of reference memory dumps to identify similarity values of the plurality of reference memory dumps to the memory dump. A developer is identified and assigned to process the memory dump for the given error event based on the comparing similarity. In an embodiment, a data storage stores the plurality of reference memory dumps, which include the list of operations of the machine code instructions for each of the reference memory dumps, and for example, a case description, a resolution statement of the memory dump, and developer information.

While the foregoing is directed to embodiments of the present invention, other and further embodiments of the invention may be devised without departing from the basic scope thereof, and the scope thereof is determined by the claims that follow.

What is claimed is:

1. A method comprising:
obtaining a memory dump for a given error event causing a system failure;
generating trace information of the memory dump to identify an instruction causing the system failure of the memory dump and a memory location of the instruction;
extracting a plurality of machine code instructions preceding the instruction causing the system failure based on the memory location;
removing a data part and not operations of the instructions being executed, from the plurality of machine code instructions, to generate a list of operations of the machine code instructions; and
comparing the list of operations of the machine code instructions to a plurality of reference memory dumps to identify similarity values of the plurality of reference memory dumps to the memory dump.

2. The method of claim 1, further comprising:
identifying a developer to process the memory dump for the given error event based on the similarity values.

3. The method of claim 1, further comprising:
storing the memory dump in a data storage, wherein the memory dump comprises storing a case description, the list of operations of the machine code instructions of the memory dump, and a resolution statement of the memory dump.

4. The method of claim 1, wherein storing the memory dump further comprises storing one or more of a system description of the memory dump, a resolution statement of the memory dump, and developer information of a developer assigned to process the memory dump.

5. The method of claim 1, wherein generating trace information of the memory dump to identify the memory location of the instruction causing the system failure further comprises identifying the memory location based on an instruction set architecture (ISA) of a processor executing the machine code instructions of the system failure.

6. The method of claim 1, wherein extracting the plurality of machine code instructions preceding the instruction based on the memory location further comprises starting at the instruction causing the system failure, and collecting a plurality of instructions until a name of a code module that includes the instruction causing the system failure is found.

7. The method of claim 1, wherein extracting the plurality of machine code instructions preceding the instruction based on the memory location further comprises creating a graph of the list of operations of the machine code instructions.

8. The method of claim 7, wherein comparing the list of operations of the machine code instructions to the plurality of reference memory dumps to identify similarity values of the plurality of reference memory dumps to the memory dump further comprises comparing the graph of the list of operations of the machine code to the plurality of reference memory dumps to identify similarity values of the plurality of reference memory dumps to the memory dump.

9. The method of claim 1, wherein comparing the list of operations of the machine code instructions to the plurality of reference memory dumps to identify similarity values of the plurality of reference memory dumps to the memory dump further comprises identifying a control window including the instruction causing the system failure and the list of operations of the machine code instructions; and identifying a number of instructions within the control window of the memory dump matching instructions of respective reference memory dumps to identify similarity values of the plurality of reference memory dumps to the memory dump.

10. The method of claim 1, wherein generating trace information of the memory dump to identify the memory location of the instruction causing the system failure further comprises identifying the memory location based on domain knowledge of a Complex Instruction Set Computer (CICS) processor.

11. A system, comprising one or more computer processors; and a memory containing a program which when executed by the one or more computer processors performs an operation, the operation comprising:
obtaining a memory dump for a given error event causing a system failure;
generating trace information of the memory dump to identify an instruction causing the system failure of the memory dump and a memory location of the instruction;
extracting a plurality of machine code instructions preceding the instruction causing the system failure based on the memory location;
removing a data part and not operations of the instructions being executed, from the plurality of machine code instructions, to generate a list of operations of the machine code instructions; and
comparing the list of operations of the machine code instructions to a plurality of reference memory dumps to identify similarity values of the plurality of reference memory dumps to the memory dump.

12. The system of claim 11, further comprising:
identifying a developer to process the memory dump for the given error event based on the similarity values.

13. The system of claim 11, wherein generating trace information of the memory dump to identify the memory location of the instruction causing the system failure further comprises identifying the memory location based on an instruction set architecture (ISA) of a processor executing the machine code instructions of the system failure.

14. The system of claim 11, wherein extracting a plurality of machine code instructions preceding the instruction causing the system failure based on the memory location further comprises:
creating a graph of the list of operations of the machine code instructions; and
comparing the graph of the list of operations of the machine code instructions to the plurality of reference memory dumps to identify similarity values of the plurality of reference memory dumps to the memory dump.

15. The system of claim 11, wherein comparing similarity of the list of operations of the machine code instructions and the plurality of reference memory dumps to identify matching similarity of the memory dumps further comprises:
identifying a control window including the instruction causing the system failure and the list of operations of the machine code instructions; and
identifying a number of instructions within the control window of the memory dump matching instructions of respective reference memory dumps to identify similarity values of the plurality of reference memory dumps to the memory dump.

16. A computer program product comprising a computer-readable storage medium having computer-readable program code embodied therewith, the computer-readable program code executable by one or more computer processors to perform an operation comprising:
obtaining a memory dump for a given error event causing a system failure;
generating trace information of the memory dump to identify an instruction causing the system failure of the memory dump and a memory location of the instruction;
extracting a plurality of machine code instructions preceding the instruction causing the system failure based on the memory location;
removing a data part and not operations of the instructions being executed, from the plurality of machine code instructions, to generate a list of operations of the machine code instructions; and
comparing the list of operations of the machine code instructions to a plurality of reference memory dumps to identify similarity values of the plurality of reference memory dumps to the memory dump.

17. The computer program product of claim 16, further comprising:
identifying a developer to process the memory dump for the given error event based on the comparing similarity.

18. The computer program product of claim 16, wherein generating trace information of the memory dump to identify the memory location of the instruction causing the system failure further comprises identifying the memory location based on an instruction set architecture (ISA) of a processor executing the machine code instructions of the system failure.

19. The computer program product of claim 16, wherein extracting a plurality of machine code instructions preceding the instruction causing the system failure based on the memory location further comprises:
creating a graph of the list of operations of the machine code instructions; and
comparing the graph of the list of operations of the machine code instructions to the plurality of reference memory dumps to identify similarity values of the plurality of reference memory dumps to the memory dump.

20. The computer program product of claim 16, wherein comparing similarity of the list of operations of the machine code instructions and the plurality of reference memory dumps to identify matching similarity of the memory dumps further comprises:
identifying a control window including the instruction causing the system failure and the list of operations of the machine code instructions; and
identifying a number of instructions within the control window of the memory dump matching instructions of respective reference memory dumps to identify similarity values of the plurality of reference memory dumps to the memory dump.
